(19) United States
(12) Patent Application Publication
(10) Pub. No.: US 2024/0055248 A1
(43) Pub. Date: Feb. 15, 2024

(54) Mass Spectrometer Sampler Cones and Interfaces and Methods of Sealing Them to Each Other

(71) Applicant: PerkinElmer Scientific Canada ULC, Woodbridge (CA)

(72) Inventors: Hamid Badiei, Woodbridge (CA); Brian Chan, Markham (CA)

(73) Assignee: PerkinElmer Scientific Canada ULC, Woodbridge, ON (CA)

(21) Appl. No.: 18/384,075

(22) Filed: Oct. 26, 2023

Related U.S. Application Data
(62) Division of application No. 16/662,545, filed on Oct. 24, 2019.
(60) Provisional application No. 62/750,114, filed on Oct. 24, 2018.

(51) Int. Cl. H01J 49/06; H01J 49/10; H01J 49/04

(52) U.S. Cl. CPC H01J 49/068; H01J 49/105; H01J 49/04; H01J 49/067

(57) ABSTRACT

Certain configurations of a sampler cone and its use with a metal gasket to seal the sampler cone to a mass spectrometer interface are described. The sampler cone, interface or both may comprise one or more surface features. Coupling of the sampler cone to the interface can compress or crush the metal gasket to provide a seal between the sampler cone and the interface. For example, a crushing force provided by surface features of the sampler cone and interface can crush the gasket and provide a substantially fluid tight seal between the sampler cone and the interface.

### PRIORITY APPLICATION

This application is a divisional of U.S. application Ser. No. 16/662,545, filed Oct. 24, 2019, which claims priority to, and the benefit of, U.S. Provisional Application No. 62/750,114, filed on Oct. 24, 2018, the entire disclosures of which are hereby incorporated herein by reference for all purposes.

### TECHNOLOGICAL FIELD

Certain configurations of mass spectrometer sampler cones, metal gaskets and interfaces that can be used together to provide a seal.

### BACKGROUND

Mass spectrometer analysis requires various vacuum stages often operating at pressure significantly below atmospheric pressure. Leaks can develop between various components in the system, which can lead to inaccuracies in mass measurements and reduced precision.

### SUMMARY

In an aspect, a mass spectrometer assembly comprises a sampler cone, a mass analyzer interface and a gasket. In some examples, the sampler cone comprises a sample orifice configured to fluidically couple to an ionization source that provides a fluid beam comprising ions to the sample orifice, wherein the sampler cone comprises a first surface feature on a surface of the sampler cone. In certain examples, the mass analyzer interface can be configured to couple to the sampler cone, wherein the mass analyzer interface comprises a second surface feature on a surface of the interface. In some configurations, the gasket can be present between the first surface feature and the second surface feature, wherein the first surface features provides a force to a first surface of the gasket and the second surface feature provides a force to a second surface of the gasket to provide a substantially fluid tight seal (or a fluid tight seal) between the sampler cone and the interface when the sampler cone is coupled to the interface.

In certain embodiments, the first surface feature of the sampler cone comprises a recess and the second surface feature of the mass analyzer interface comprises a projection, and wherein the recess is configured to engage the projection and crush the gasket between the recess and the projection to provide the substantially fluid tight seal (or the fluid tight seal) between the sampler cone and the interface as the sampler cone is coupled to the mass analyzer interface. In other embodiments, the first surface feature of the sampler cone comprises a projection and the second surface feature of the interface comprises a recess, and wherein the projection is configured to engage the recess and crush the gasket between the recess and the projection to provide the substantially fluid tight seal (or the fluid tight seal) between the sampler cone and the interface as the sampler cone is coupled to the mass analyzer interface. In some examples, the sampler cone further comprises threads configured to couple to threads on the mass analyzer interface. In other examples, the first surface feature of the sampler cone comprises a first projection and the second surface feature of the mass analyzer interface comprises a second projection, and wherein the first projection is configured to provide the force to the first surface of the gasket and the second projection is configured to provide the force to the second surface of the gasket to compress the gasket to provide the substantially fluid tight seal (or the fluid tight seal) between the sampler cone and the mass analyzer interface. In certain embodiments, at least one of the sampler cone and the mass analyzer interface further comprises an additional surface feature. In other embodiments, the gasket comprises a metal gasket with a thickness of about 0.1 mm to about 0.5 mm. In some examples, the first surface feature, the second surface feature and the gasket each comprises a material with a substantially similar coefficient of thermal expansion. In other examples, the gasket is a multi-layer metal gasket.

In some embodiments, the gasket comprises a thickness of about 0.2 mm to about 0.25 mm, wherein the first surface feature is configured as a triangular projection with a height of less than 1 mm and the second surface feature is configured as a triangular projection with a height of less than 1 mm.

In other embodiments, the gasket comprises a thickness of about 0.2 mm to about 0.25 mm, wherein the first surface feature is configured as a triangular projection with a height of less than 1 mm and the second surface feature is configured as a triangular recess with a depth of less than 1 mm.

In some configurations, the gasket comprises a thickness of about 0.2 mm to about 0.25 mm, wherein the first surface feature is configured as a triangular recess with a depth of less than 1 mm and the second surface feature is configured as a triangular projection with a height of less than 1 mm.

In another aspect, a method of sealing a sampler cone to a mass analyzer interface is described. In some instances, the method comprises coupling a sampler cone to the mass analyzer interface to provide a substantially fluid tight seal (or a fluid tight seal) between the sampler cone and the mass analyzer interface by crushing a metal gasket between a first surface feature of the sampler cone and a second surface feature of the mass analyzer interface to provide the substantially fluid tight seal (or the fluid tight seal) between the sampler cone and the mass analyzer interface.

In some examples, the method comprises tightening first threads of the sampler cone to second threads of the mass analyzer interface crushes the metal gasket between the first surface feature and the second surface feature. In some instances, the first surface feature of the sampler cone comprises a recess and the second surface feature of the mass analyzer interface comprises a projection, and wherein the recess is configured to engage the projection and crush the gasket between the recess and the projection to provide the substantially fluid tight seal (or the fluid tight seal) between the sampler cone and the interface as the sampler cone is coupled to the interface. In other instances, the first surface feature of the sampler cone comprises a projection and the second surface feature of the mass analyzer interface comprises a recess, and wherein the projection is configured to engage the recess and crush the gasket between the recess and the projection to provide the substantially fluid tight seal (or the fluid tight seal) between the sampler cone and the interface as the sampler cone is coupled to the mass analyzer interface. In some embodiments, the first surface feature of the sampler cone comprises a first projection and the second surface feature of the mass analyzer interface comprises a second projection, and wherein the first projection is configured to provide the force to the first surface of the gasket and the second projection is configured to provide the force to the second surface of the gasket to compress the gasket to provide the substantially fluid tight seal (or the fluid tight seal).

In some examples, the gasket comprises a thickness of about 0.2 mm to about 0.25 mm, wherein the first surface feature is configured as a triangular projection with a height of less than 1 mm and the second surface feature is configured as a triangular projection with a height of less than 1 mm.

In certain examples, the first surface feature, the second surface feature and the gasket each comprises a material with a substantially similar (or the same) coefficient of thermal expansion. In some examples, the gasket is a multi-layer metal gasket.

In another aspect, a mass spectrometer comprises a sampler cone comprising a sample orifice configured to fluidically couple to an ionization source that provides a fluid beam comprising ions to the sample orifice, wherein the sampler cone comprises a first surface feature on a surface of the sampler cone, a mass analyzer interface configured to couple to the sampler cone, wherein the mass analyzer interface comprises a second surface feature on a surface of the mass analyzer interface, a gasket between the first surface feature and the second surface feature, wherein the first surface features provides a force to a first surface of the gasket and the second surface feature provides a force to a second surface of the gasket to provide a substantially fluid tight seal (or the fluid tight seal) between the sampler cone and the interface when the sampler cone is coupled to the mass analyzer interface, and a mass analyzer.

In certain configurations, the mass spectrometer comprises a sample introduction device fluidically coupled to an ionization source, wherein the ionization source is fluidically coupled to the orifice of the sampler cone. In other configurations, the mass spectrometer comprises a detector. In some examples, the ionization source comprises an inductively coupled plasma. In certain examples, the mass analyzer comprises at least one quadrupole. In some embodiments, the detector comprises an electron multiplier. In some examples, the first surface feature of the sampler cone comprises a recess and the second surface feature of the mass analyzer interface comprises a projection, and wherein the recess is configured to engage the projection and crush the gasket between the recess and the projection to provide the substantially fluid tight seal (or the fluid tight seal) between the sampler cone and the mass analyzer interface as the sampler cone is coupled to the mass analyzer interface. In other examples, the first surface feature of the sampler cone comprises a projection and the second surface feature of the mass analyzer interface comprises a recess, and wherein the projection is configured to engage the recess and crush the gasket between the recess and the projection to provide the substantially fluid tight seal (or the fluid tight seal) between the sampler cone and the interface as the sampler cone is coupled to the mass analyzer interface. In other embodiments, the first surface feature of the sampler cone comprises a first projection and the second surface feature of the mass analyzer interface comprises a second projection, and wherein the first projection is configured to provide the force to the first surface of the gasket and the second projection is configured to provide the force to the second surface of the gasket to compress the gasket to provide the substantially fluid tight seal (or the fluid tight seal) between the sampler cone and the mass analyzer interface. In some embodiments, the gasket comprises a thickness of about 0.1 mm to about 0.5 mm.

In another aspect, a kit comprises a sampler cone comprising a sample orifice configured to fluidically couple to an ionization source that provides a fluid beam comprising ions to the sample orifice, wherein the sampler cone comprises a first surface feature configured to engage a second surface feature on an interface of a mass spectrometer, a gasket, e.g., a metal gasket, sized and arranged to be placed between the first surface feature of the sampler cone and the second surface feature of the interface and configured to be crushed between the first surface feature of the sampler cone and the second surface feature of the interface when the sampler cone is coupled to the interface of the mass spectrometer; and written or electronic instructions for using the sampler cone and the metal gasket to couple the sampler cone to the interface of the mass spectrometer to provide a substantially fluid tight seal (or the fluid tight seal) between the sampler cone and the interface of the mass spectrometer. In some examples, the kit comprises the interface. In other examples, the kit comprises a tool comprising a pre-set torque to tighten threads of the sampler cone to threads of the interface to crush the metal gasket and provide the substantially fluid tight seal.

In another aspect, a mass spectrometer sampler cone comprises a sample orifice configured to fluidically couple to an ionization source that provides a fluid beam comprising ions to the sample orifice, and a first surface feature on a surface of the sampler cone, wherein the first surface feature is configured to provide a force to a surface of a metal gasket to crush the metal gasket between the first surface feature of the sampler cone and a second surface feature of a mass analyzer interface to provide a substantially fluid tight seal (or the fluid tight seal) between the sampler cone and the mass analyzer.

In certain embodiments, the first surface feature of the sampler cone comprises a recess. In other embodiments, the first surface feature of the sampler cone comprises a projection. In some examples, the sampler cone further comprises threads configured to couple to threads on the mass analyzer interface.

In an additional aspect, a mass spectrometer interface configured to couple to a sampler cone comprises a first surface feature, wherein the first surface feature is configured to provide a force to a surface of a metal gasket to crush the metal gasket between the first surface feature of the mass spectrometer interface and a second surface feature of a sampler cone to provide a substantially fluid tight seal (or the fluid tight seal) between the sampler cone and the mass spectrometer interface.

In some examples, the first surface feature of the mass spectrometer interface comprises a recess. In other examples, the first surface feature of the mass spectrometer interface cone comprises a projection. In some examples, the mass spectrometer interface further comprises threads configured to couple to threads on the sampler cone.

In another aspect, a mass spectrometer sampler cone comprising a sample orifice and a surface feature is described. In some configurations, the sample orifice is configured to fluidically couple to an ionization source that provides a fluid beam comprising ions to the sample orifice. In certain examples, the sampler cone comprises a surface feature on a surface of the sampler cone, wherein the surface feature is configured to engage and crush a metal gasket between the surface feature of the sampler cone and a surface feature of an interface of a mass spectrometer to provide a substantially fluid tight seal between the sampler cone and the interface of the mass analyzer.

In certain embodiments, the surface feature of the sampler cone comprises a recess and the surface feature of the interface comprises a projection, and wherein the recess is configured to engage the projection and crush the metal gasket between the recess and the projection as the sampler cone is tightened to the interface. In other embodiments, the surface feature of the sampler cone comprises a projection and the surface feature of the interface comprises a recess, and wherein the projection is configured to engage the recess and crush the metal gasket between the recess and the projection as the sampler cone is tightened to the interface.

In some examples, the sampler cone further comprises threads configured to couple to threads on the interface.

In other examples, the surface feature of the sampler cone comprises a circular recess and the surface feature of the interface comprises a circular projection, and wherein the circular recess is configured to engage the circular projection through the metal gasket to crush the metal gasket between the circular recess and the circular projection to provide the substantially fluid tight seal (or fluid tight seal) between the sampler cone and the interface of the mass analyzer. In some examples, the circular recess comprises a depth of less than 1 mm, and wherein the metal gasket comprises a thickness less than 0.5 mm.

In other examples, the sampler cone comprises a similar material as the metal gasket. In some embodiments, the sampler cone comprises one or more of aluminum, nickel, platinum or a nickel base with a platinum tip.

In certain embodiments, the sampler cone comprises a conical shape with an inner diameter of the sampler cone increasing from the sample orifice to a base of the sampler cone where the surface feature of the sampler cone is present.

In other embodiments, the sampler cone comprises a second surface feature on the sampler cone, wherein the second surface feature is separate from the surface feature.

In an additional aspect, a mass spectrometer interface comprises first threads configured to couple to second threads of a sampler cone. In some examples, the interface further comprises a first surface feature configured to engage a second surface feature on a sampler cone. In some configurations, the first surface feature and the second surface feature crush a metal gasket positioned between the first surface feature and the second surface feature to provide a substantially fluid tight seal (or fluid tight seal) between the sampler cone and the interface when the second threads of the sampler cone are mated to the first threads of the interface.

In some embodiments, the first surface feature of the interface comprises a recess and wherein the second surface feature of the sampler cone comprises a projection, and wherein the recess is configured to engage the projection to crush the metal gasket between the recess and the projection as the sampler cone is tightened to the interface.

In other embodiments, the first surface feature of the interface comprises a projection and wherein the second surface feature of the sampler cone comprises a recess, and wherein the projection is configured to engage the recess to crush the metal gasket between the recess and the projection as the sampler cone is tightened to the interface.

In additional embodiments, the first surface feature of the interface comprises a circular recess and wherein the second surface feature of the sampler cone comprises a circular projection, and wherein the circular recess is configured to engage the circular projection to crush the metal gasket between the circular recess and the circular projection to provide the substantially fluid tight seal (or fluid tight seal) between the sampler cone and the interface of the mass analyzer. In some examples, the circular recess comprises a depth of less than 1 mm, and wherein the metal gasket comprises a thickness less than 0.5 mm.

In other examples, the first surface feature of the interface comprises a circular projection and the second surface feature of the sampler cone comprises a circular recess, and wherein the circular projection is configured to engage the circular recess to crush the metal gasket between the circular projection and the circular recess to provide the substantially fluid tight seal (or fluid tight seal) between the sampler cone and the interface of the mass analyzer.

In some embodiments, the interface comprises a similar material as the metal gasket. In other embodiments, the interface comprises aluminum.

In some examples, the mass spectrometer interface comprises a second surface feature on the interface, wherein the second surface feature is separate from the surface feature.

In some embodiments, the interface is configured to couple to the sampler cone without the use of a rubber O-ring between the interface and the sampler cone.

In another aspect, a mass spectrometer comprises a sampler cone comprising a sample orifice configured to fluidically couple to an ionization source that provides a fluid beam comprising ions to the sample orifice, wherein the sampler cone comprises first threads and a first surface feature. The mass spectrometer may also comprise a metal gasket, and an interface coupled to a mass analyzer and comprising second threads configured to couple to the first threads of a sampler cone, wherein the interface further comprises a second surface feature configured to engage the first surface feature of the sampler cone, wherein when the first threads of the sampler cone are mated to the second threads of the interface the metal gasket is crushed between the first surface feature and the second surface feature to provide a substantially fluid tight seal (or fluid tight seal) between the sampler cone and the interface.

In certain embodiments, the mass spectrometer comprises a sample introduction device, an ionization source, and a detector, wherein the sample introduction device is fluidically coupled to the ionization source, wherein the sample orifice of the sampler cone is fluidically coupled to the ionization source, and wherein the mass analyzer is fluidically coupled to the detector. In some embodiments, the ionization source comprises an inductively coupled plasma. In other examples, the mass analyzer comprises at least one quadrupole. In some embodiments, the detector comprises an electron multiplier. In other examples, the detector comprises a time of flight device.

In certain embodiments, the first surface feature of the sampler cone comprises a recess, and wherein the second surface feature of the interface comprises a projection configured to engage the recess, and wherein the metal gasket is positioned between the recess and the projection and is crushed when the first threads of the sampler cone are mated to the second threads of the interface.

In some examples, the first surface feature of the sampler cone comprises a projection and wherein the second surface feature of the interface comprises a recess configured to engage the projection, and wherein the metal gasket is positioned between the projection and the recess and is crushed when the first threads of the sampler cone are mated to the second threads of the interface.

In other examples, the first surface feature of the sampler cone comprises a circular recess and wherein the seconds surface feature of the interface comprises a circular projection configured to engage the circular recess, and wherein the metal gasket is positioned between the circular recess and the circular projection and is crushed when the first threads of the sampler cone are mated to the second threads of the interface.

In further embodiments, the first surface feature of the sampler cone comprises a circular projection and wherein the seconds surface feature of the interface comprises a circular recess configured to engage the circular projection, and wherein the metal gasket is positioned between the circular projection and the circular recess and is crushed when the first threads of the sampler cone are mated to the second threads of the interface.

In another aspect, a kit comprises a sampler cone, a metal gasket and instructions for using the sampler cone and gasket. In some embodiments, the sampler cone of the kit comprises a sample orifice configured to fluidically couple to an ionization source that provides a fluid beam comprising ions to the sample orifice, wherein the sampler cone comprises a first surface feature configured to engage a second surface feature on an interface. In some embodiments, the metal gasket can be sized and arranged to be placed between the first surface feature of the sampler cone and the second surface feature of the interface and configured to be crushed between the first surface feature of the sampler cone and the second surface feature of the interface when the sampler cone is coupled to the interface of the mass analyzer. In certain instances, the kit comprises instructions for using the sampler cone and the metal gasket to couple the sampler cone to the interface of the mass analyzer to provide a substantially fluid tight seal (or fluid tight seal) between the sampler cone and the interface of the mass analyzer.

In some examples, the kit may also comprise the interface. In other examples, the kit may comprise a tool comprising a pre-set torque to tighten the sampler cone to the interface to crush the metal gasket and provide the substantially fluid tight seal (or fluid tight seal) without overtightening the sampler cone.

In an additional aspect, a method of coupling a sampler cone to a mass analyzer interface to provide a substantially fluid tight seal (or fluid tight seal) between the sampler cone and the mass analyzer interface is provided. In some examples, the method comprises crushing a metal gasket between a first surface feature of the sampler cone and a second surface feature of the mass analyzer interface to provide the substantially fluid tight seal (or fluid tight seal) between the sampler cone and the mass analyzer interface. In other examples, the method comprises tightening first threads of the sampler cone to second threads of the mass analyzer interface to a selected torque value to crush the metal gasket between the first surface feature and the second surface feature.

Additional features, aspects, embodiments and configurations are described in more detail below.

### BRIEF DESCRIPTION OF THE SEVERAL VIEWS OF THE DRAWINGS

Certain embodiments and configurations are described with reference to the accompanying figures in which:

FIG. 1 is an illustration of a sampler cone and interface, in accordance with some examples;

FIG. 2A is an exploded view of a sampler cone, metal gasket and an interface, and FIG. 2B is an illustration showing the components of FIG. 2A assembled to each other, in accordance with certain configurations;

FIG. 2C is an exploded view of a sampler cone, metal gasket and an interface, and FIG. 2D is an illustration showing the components of FIG. 2C assembled to each other, in accordance with certain configurations;

FIG. 3 is an illustration of a sampler cone comprising a surface feature configured as a projection and an interface comprising a surface feature configured as a recess, in accordance with some embodiments;

FIG. 4 is an illustration of a sampler cone comprising a surface feature configured as a recess and an interface comprising a surface feature configured as a recess, in accordance with some embodiments;

FIG. 5 is an illustration of a sampler cone comprising a surface feature configured as a projection and an interface comprising a surface feature configured as a projection, in accordance with certain embodiments;

FIG. 6A is an illustration of a metal gasket with a top surface comprising a projection, in accordance with certain examples;

FIG. 6B is an illustration a metal gasket with a top surface comprising a U-shape, in accordance with certain examples;

FIG. 6C is an illustration a metal gasket with a top surface and a bottom surface each comprising a U-shape, in accordance with certain examples;

FIG. 6D is an illustration a metal gasket with a top surface comprising a U-shape and a bottom surface comprising a projection, in accordance with certain examples;

FIG. 6E is an illustration of a gasket with a top surface having a different length than a bottom surface, in accordance with some configurations;

FIG. 6F is an illustration of a gasket comprising a recess in each surface, in accordance with certain examples;

FIG. 6G is an illustration of a gasket comprising offset recesses in each surface, in accordance with some embodiments;

FIG. 6H is an illustration of a gasket comprising different materials across a surface of the gasket, in accordance with some examples;

FIG. 6I is an illustration of a gasket comprising a different thickness across a surface of the gasket, in accordance with some examples;

FIG. 7A is an disassembled view of a gasket, and two components each comprising a surface feature, and FIG. 7B is an assembled view of the components of FIG. 7A, in accordance with some examples;

FIG. 8A is an assembled view of two components each comprising surface features with a planar surface that can provide a compressive force to a gasket, in accordance with certain examples;

FIG. 8B is an assembled view of two components where one component comprises a surface feature with a planar surface and the other component comprises a surface features with a pointed or tipped end that can provide a compressive force to a gasket, in accordance with some examples;

FIG. 9A is an assembled view of two components where each component comprises more than one surface feature that can provide a compressive force to a gasket, in accordance with some examples;

FIG. 9B is an assembled view of two components where each component comprises more than one surface feature that can provide a compressive force to a gasket and where at least one surface feature is offset, in accordance with some examples;

FIG. 10 is an illustration of certain components in a mass spectrometer, in accordance with some embodiments;

FIG. 11 is an illustration of a sampler cone comprising a first surface feature and a second surface feature on a mating surface of the sampler cone, in accordance with certain embodiments;

FIG. 12 is a flow chart showing how a sampler cone and interface can be coupled to each other through a gasket to provide a substantially fluid tight seal between them, in accordance with some examples;

FIG. 13 is a cross-section of a sampler cone showing a recess or dimple at a peripheral edge of a bottom surface of the sampler cone, in accordance with some configurations;

FIG. 14 is an illustration of a sampler cone comprising a projection, a metal gasket and an interface comprising a groove, in accordance with certain embodiments; and

FIGS. 15A and 15B show two components and a gasket that can be used to provide a substantially fluid tight seal.

It will be recognized by the skilled person in the art, given the benefit of this disclosure, that the various components shown in the figures are not necessarily shown to scale. Certain features may be enlarged or otherwise distorted to facilitate a better understanding. For example, the thickness of the gasket may be increased to illustrate better how one component couples to or applies a force to another component. Illustrative thicknesses for the gaskets are described and no particular gasket thickness, based on the relative sizes of the components shown in the figures, is intended from the exemplary configurations shown in the figures.

### DETAILED DESCRIPTION

Certain configurations are described of sampling cones that can be used to form a seal with a mass spectrometer interface without the need to have highly polished or planar surfaces. For example, a flat metal gasket can be positioned between surface features on each of a sampler cone and an interface and can be crushed between the surface features to assist in sealing the sampler cone to the interface. In certain instances, the sampler cone and/or interface does not need to rely on the seal made between flat and highly polished surfaces and instead can implement a crush seal approach optionally in combination with surface features on the sampler cone and/or surface features on the interface to seal the interface to the sampler cone. The seal can be provided by torqueing down the sampler cone to the interface with a crush washer or gasket between them assisting in production of a fluid tight seal between the two components. Tightening of the sampler cone to the interface results in distortion or “crushing” of at least some portion of the metal gasket, to at least some degree, to provide the seal between the components. As noted in more detail below, a portion or all of the metal gasket can be sandwiched or crushed between other components to assist in providing a substantially fluid tight seal.

Reference is made herein in certain instances to “projections” or “recesses.” These terms are used to provide a more user-friendly description and signify the presence of a surface feature which is positioned, at least to some extent, above a surface, in the case of a projection, or penetrates into a surface, in the case of a recess, to provide some open space along the surface. Unless specified in reference to a particular configuration, no particular shape, width, height, length or configuration is intended to be required by the use of these terms. Reference is also made to a “substantially fluid tight seal,” which refers to a seal between the sampler cone and the interface such that little or no gas can leak into the vacuum stages of the mass analyzer from the sampler cone/interface surfaces. If desired, the seal between the sampler cone and the interface may be fluid tight such that zero gas can be drawn into the mass analyzer through any space between the sampler cone and the interface, except for the sampler orifice.

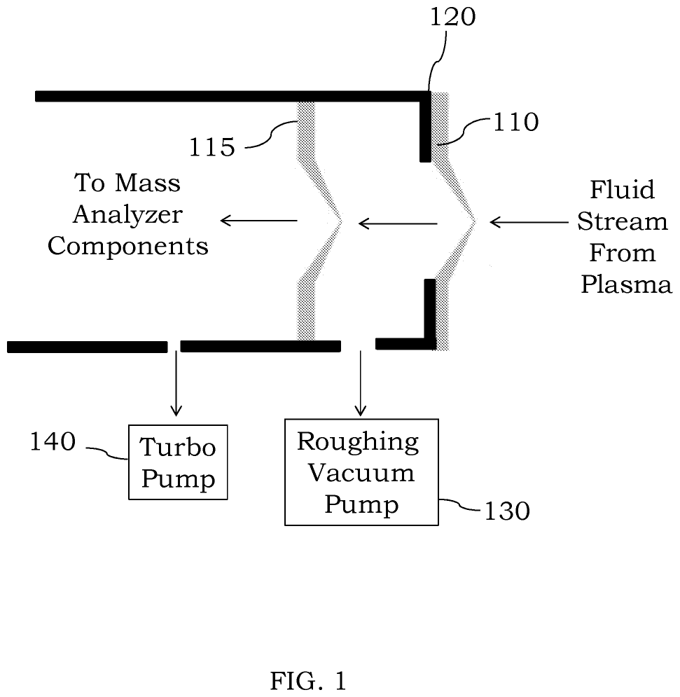

In certain embodiments, a general schematic of certain components of a mass spectrometer (MS) is shown in FIG. 1. A sampler cone 110 is shown as being coupled to an edge 120 of interface of a mass analyzer. Without wishing to be bound by any particular configuration, the interface is generally the point or region from which an ionized sample is introduced into the mass analyzer portion. The interface permits fluidic coupling of the ionization device or ion producing stage of the MS and the mass analyzer stage of the MS. For example, where inductively coupled plasmas (ICP's) are used as the ionization source, ions exit the torch that sustains the ICP in the form of a hot fluid stream, e.g., a hot gas stream, that comprises ions, photons and other species produced in the plasma. The fluid stream then impacts the sampler cone 110. While many different configurations exist, the sampler cone 110 often is configured as a water-cooled cone with a small orifice that is used to permit only a smaller portion of the entire fluid stream from the ICP to enter into the mass analyzer stage. The temperature of the existing fluid stream is often very hot, whereas downstream of the sampler cone 110 the temperature is much lower due to reduced pressures. Supersonic expansion is the result of pressure difference across the sampler cone orifice. The drop in temperature is a consequence of the supersonic expansion where the plasma energy in the form of heat is converted to a directed velocity within the free-jet region. A portion of the fluid permitted to pass by the sampler cone 110 is often provided to a skimmer cone 115 for further confinement/selection of the fluid stream and can be provided to downstream components of the mass analyzer, e.g., to lenses, collision cells, ion guides, ion deflectors, mass filters, etc. The mass analyzer can be maintained at a pressure significantly below that of atmospheric pressure using one or more vacuum pumps such as roughing pump 130 and turbo pump 140.

In certain examples, to maintain the vacuum in the different stages of the mass analyzer using the pumps 130, 140, a fluid tight seal between the sampling cone 110 and the edge 120 of the interface is needed so fluid only enters into the mass analyzer through the small orifice in the sampler cone 110.

In certain embodiments, to avoid or reduce the problems associated with coupling a sampler cone to an interface using a rubber O-ring, certain configurations described herein advantageously include a suitable shape or surface feature on or in a surface of the sampler cone that can engage or otherwise receive a suitable shape or surface feature on or in a surface of an interface. In other instances, the sampler cone may be configured to sandwich or crush a gasket between two or more components to provide a substantially fluid tight seal. For example, a thin metal crush gasket, washer or seal can be positioned between the surface features of the sampler cone and interface so engagement of the sampler cone surface feature to the interface surface features crushes the thin metal gasket and provides a seal between the sampler cone and the interface. Alternatively, a thin metal crush gasket, washer or seal can be positioned between the surface features of the sampler cone such that placing surface features in proximity to each other can sandwich or crush the thin metal crush gasket and effectuate the substantially fluid tight seal. By using a metal gasket/seal along with suitably configured sampler cones and/or interfaces, improved sealing and heat transfer can be achieved. In addition, the use of a metal gasket/seal avoids the need to have highly polished mating surfaces on the sampler cone and the interface.

For example, the surfaces of the sampler cone and/or interface where the surface projections are present could be non-planar. Further, the surface features need not have any particular shape or geometry and can be designed, for example, to amplify the force at a given area to enhance sealing at the contact point(s) between the gasket and component.

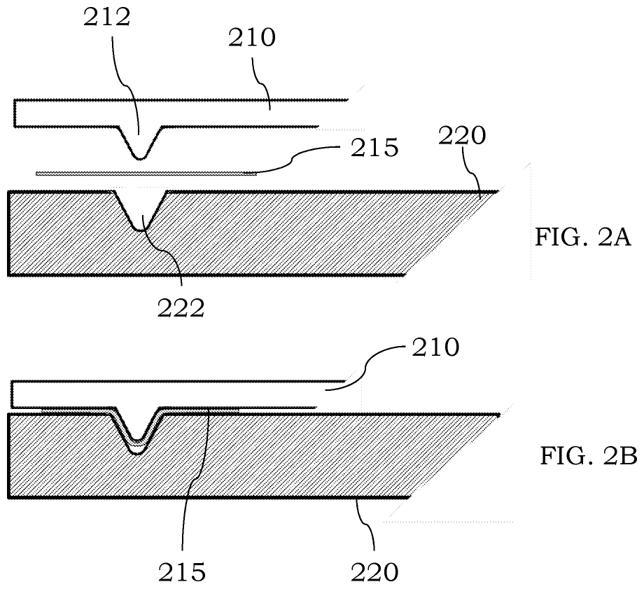

In certain examples and referring to FIG. 2A, an exploded view of a cross-section of a side edge of a sampler cone/metal gasket/interface edge is shown. The sampler cone 210 comprises a surface feature 212, e.g., a projection, that, in this example, can engage a surface feature 222, e.g., a groove or recess, on an interface 220. A metal gasket 215 can be positioned between the components 210, 220 and adjacent to the surface features 212, 222. Tightening of the sampler cone 210 to the interface 220 through threads (not shown), result in crushing of the metal gasket 215 into the groove 222 as the projection 212 engages the groove 222 from the tightening process. The result of the tightening process is a substantially fluid tight seal between the sampler cone 210 and the interface 220. The metal gasket 215 is shown as being within the groove 222 and spanning across mating surfaces of the sampler cone 210 and the interface 220. In certain configurations, the metal gasket 215 generally is sized and arranged so it is crushed into the groove 222 and still remain between the mating surfaces of the sampler cone 210 and 220 at least to some extent. In such instances, the surfaces of the sampler cone 210 and the interface 220 need not necessarily be in contact when the sampler cone 210 is sealed to the interface 220.

In certain embodiments, the shape of the features of the sampler cone and interface need not be those shown in FIGS. 2A and 2B, and many other shapes are possible. Referring to FIGS. 2C and 2D, a sampler cone 250 comprises a surface feature comprising a dimple, groove or recess 252 on a surface and is configured to engage a portion of a metal gasket 255. The interface 260 includes a surface feature comprising a boss or projection 262 on a surface and is configured to insert into the recess 252 of the sampler cone 250. While not shown, the sampler cone 250 typically comprises threads that mate to threads on the interface 260 to couple the sampler cone 250 to the interface 260. In use of the components in FIG. 2C, the metal gasket 250 can be placed between the sampler cone 250 and the interface 260 prior to threading the sampler cone 250 into the interface 260. Tightening of the sampler cone 250 to the interface 260 results in compression/crushing of the metal gasket 255 between the sampler cone 250 and the interface 260 surface features 252, 262 (see FIG. 2D). The metal gasket 255 acts to seal the space between the sampler cone 250 and interface 260 to provide a substantially fluid tight seal between the sampler cone 250 and the interface 260 to assist in achieving and maintain the reduced pressures in the vacuum regions of the mass analyzer. The surface features shown in the sampler cone 250 and the interface 260 are typically three dimensional so that tightening of the sampler cone 250 to the interface 260 results in engagement of the surface features 252, 262 with the metal gasket 255 being sandwiched between the surface features 252, 262.

While threads present on the sampler cone and interface are described above as being used to couple the sampler cone to the interface, other configurations are possible. For example, there can be a retaining ring around the sampler cone which comprises the threads and no threads are present on the sampler cone. In another configuration, the sampler cone has multiple screws or bolts (or other type of external fastener) around its outer circumference and away from the seal line. The fasteners are tightened and the cone is pushed against the interface, which would also result in crushing of the metal gasket between the surface features. In other instances, the vacuum pressure itself in the vacuum manifold can be used to draw the sampler cone against the interface and crush the metal gasket to provide the seal without using any external fasteners or threads. The sampler cone may comprise many different types of materials and typical materials and generally inert and unreactive with an ions or other analytes which pass through the sample orifice of the sampler cone or otherwise contact surfaces of the sampler cone. For example, the sampler cone may comprise one or more of aluminum, nickel, platinum or a nickel base with a platinum tip. The interface may comprise similar materials as the sampler cone, e.g., aluminum, nickel, platinum, etc., though the interface materials need not be the same as the materials of the sampler cone and/or any skimmer cones that are present.

In some embodiments, the metal gaskets 215, 255 each can be configured as a generally planar metal ring or may have other shapes that generally mirror that on sampler cone. For example, the metal gaskets 215, 255 each can be circular, elliptical or have other shapes. The metal gaskets 215, 255 can also each be configured as a single layer gasket or a multi-layer gasket. Two or more separate gaskets could also be used if desired. While not required in all cases, the metal gasket may comprise a soft metal material that can crush or compress at least to some degree as the threads of the sampler cone are tightened to threads of the interface. For example, the metal gaskets 215, 255 each may independently comprise aluminum, nickel, brass, pure platinum, gold, copper or other transition metals that can be crushed, to at least some degree, upon application of a force used to tighten the sampler cone to the interface. As noted herein, a tool with a pre-set torque limit can be used to ensure the sampler cone is tightened to the interface to a suitable degree but not overtightened to deform or break the metal gasket and disrupt any seal. The metal gasket may also permit heat transfer from the sampler cone to the interface (or vice versa) as desired. The metal gasket thickness can vary, for example, from about 0.1 mm to about 0.5 mm, though these values are merely illustrative and smaller or larger thicknesses could be used if desired. The metal gasket thickness is typically sized based on the depth and/or height of any surface features present on the non-planar sampler cone and/or interface. For example, the recess on the sampler cone might be around 0.2-1 mm deep, and the height of the projection or boss on the interface can be about 0.2-1 mm high. The metal gasket can be sized so it occupies at least some of the space that may be present when the projection of the interface is coupled to the recess of the sampler cone, e.g., it can contact substantially all surfaces of the surface features of the sampler cone and interface after the metal gasket is compressed or crushed. As noted in more detail below, the metal gasket need not have the same thickness at all areas and need not be produced from the same material across the surface of the gasket. Further, the gasket may comprise indicia, indentations or other surface features which can aid in positioning the gasket at a certain site or area if desired.

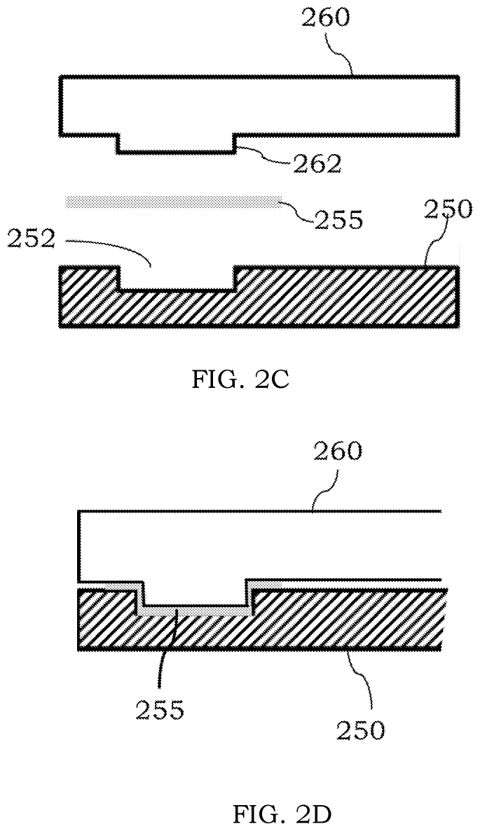

In other configurations, the sampler cone need not have a recess but could instead comprise a projection or boss. One illustration is shown in FIG. 3, where the sampler cone 310 includes a surface feature comprising a projection 312 on a non-planar mating surface that couples to a groove or recess 332 on a non-planar mating surface of an interface 330 through a metal gasket 320. Tightening of the sampler cone 310 to the interface 330 through the threads of these components results in crushing of the metal gasket 320 between the surface features 312, 332 and promotes a fluid tight seal between the components 310, 330. As noted above, configurations other than threads on the sampler cone and interface could also be used. The metal gasket 320 can be configured similar to the gasket 220. For example, the metal gasket 320 may be a single layer gasket or a multi-layer gasket. The metal gasket 320 may comprise a soft metal material that can crush or compress at least to some degree as the sampler cone 310 is tightened to the interface 330. In some examples, the metal gasket 320 may comprise aluminum, nickel, brass, pure platinum, gold, copper or other transition metals that can compress, to at least some degree, upon application of a force used to tighten the threads of the sampler cone 310 to the threads of the interface 330. As noted herein, a tool with a pre-set torque limit can be used to ensure the sampler cone 310 is tightened to the interface 330 to a suitable degree but not overtightened to deform the metal gasket 320 and disrupt any seal. The metal gasket 320 may also permit heat transfer from the sampler cone 310 to the interface 330 (or vice versa) as desired. The thickness of the gasket 320 can vary, for example, from about 0.1 mm to about 0.5 mm, though these values are merely illustrative and smaller or larger thicknesses could be used if desired. The gasket thickness is typically sized based on the depth and/or height of any surface features present on the non-planar surfaces of the sampler cone 310 and/or interface 330. For example, the recess on the interface 330 might be around 0.2-1 mm, and the height of the projection or boss on the sampler cone 310 can be about 0.2-1 mm. The metal gasket 320 can be sized so it occupies at least some of the space that may be present when the projection of the sampler cone is coupled to the recess of the interface, e.g., it can contact substantially all surfaces of the surface features of the sampler cone and interface after the metal gasket is compressed or crushed.

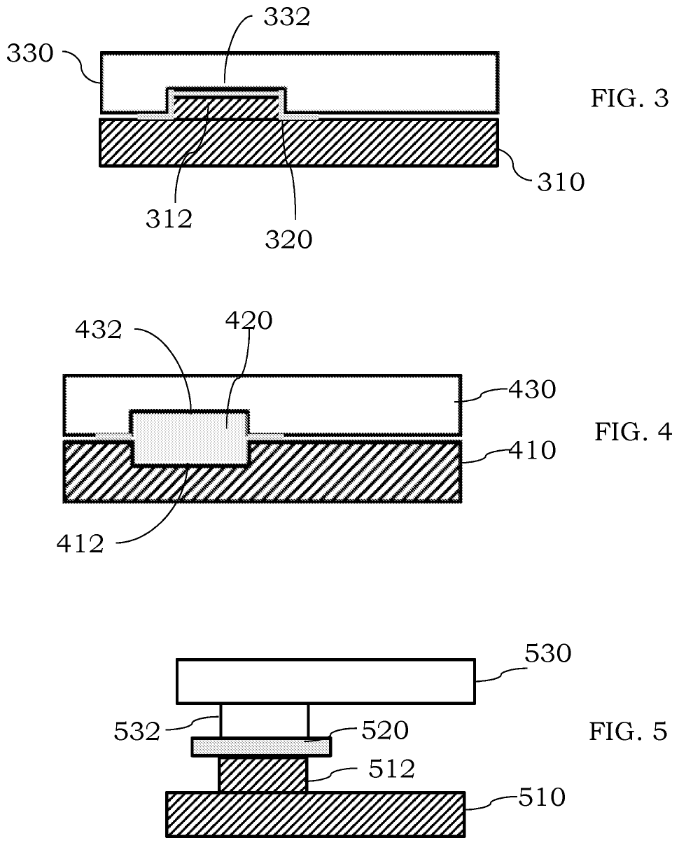

In certain embodiments, the sampler cone and the interface could each have a recess or other inward surface feature designed to mate to/engage a metal gasket. In such cases, the gasket thickness itself may be increased, or the gasket may have a variable thickness across a surface of the metal gasket, so when it is crushed or compressed it is pushed into the recesses of each of the sampler cone and the interface. An illustration is shown in FIG. 4, where the sampler cone 410 includes a surface feature comprising a recess 412 on a surface that couples to a recess 432 on a surface of an interface 430 through a metal gasket 420. Tightening of the sampler cone 410 to the interface 430 through the threads of these components results in compression of the metal gasket 420 between the surface features 412, 432 and promotes a substantially fluid tight seal or a fluid tight seal between the components 410, 430. As noted above, configurations other than threads on the sampler cone and interface could also be used. The metal gasket 420 pushes into the recesses 412 and 432. For example, the metal gasket 420 can be sized with a central body that is thicker than the edges to permit some portion of the gasket 420 to occupy the recesses 412, 432 when the sampler cone 410 is coupled to the interface 430. Alternatively, a plurality of different size gaskets can be stacked so that a central area of the gasket occupies at least some of the space of the recesses 412, 432. In certain embodiments, the metal gasket 420 may be a single layer gasket or a multi-layer gasket. The metal gasket 420 may comprise a soft metal material that can compress at least to some degree as the sampler cone 410 is tightened to the interface 430. In some examples, the metal gasket 420 may comprise aluminum, nickel, brass, pure platinum, gold, copper or other transition metals that can crush or compress, to at least some degree, upon application of a force used to tighten the threads of the sampler cone 410 to the threads of the interface 430. As noted herein, a tool with a pre-set torque limit can be used to ensure the sampler cone 410 is tightened to the interface 430 to a suitable degree but not overtightened to deform the metal gasket 420 and disrupt any seal. The metal gasket 420 may also permit heat transfer from the sampler cone 410 to the interface 430 (or vice versa) as desired. The thickness of the gasket 420 can vary, for example, from about 0.1 mm to about 0.5 mm, though these values are merely illustrative and smaller or larger thicknesses could be used if desired. The gasket thickness is typically sized based on the depth of the recesses present on the surfaces of the sampler cone 410 and/or interface 430. For example, the recesses on the interface 430 and the sampler cone 410 might each independently be around 0.2-1 mm deep. The metal gasket 420 can be sized so it occupies at least some of the space that may be present when the recess of the interface is coupled to the recess of the sampler cone, e.g., it can contact substantially all surfaces of the surface features of the sampler cone and interface after the metal gasket is compressed or crushed. The recesses 412, 432 need not have planar recessed surfaces but could instead adopt many different geometries and shapes as desired including tapered recess shaped surfaces, pointed recess shaped surfaces, etc.

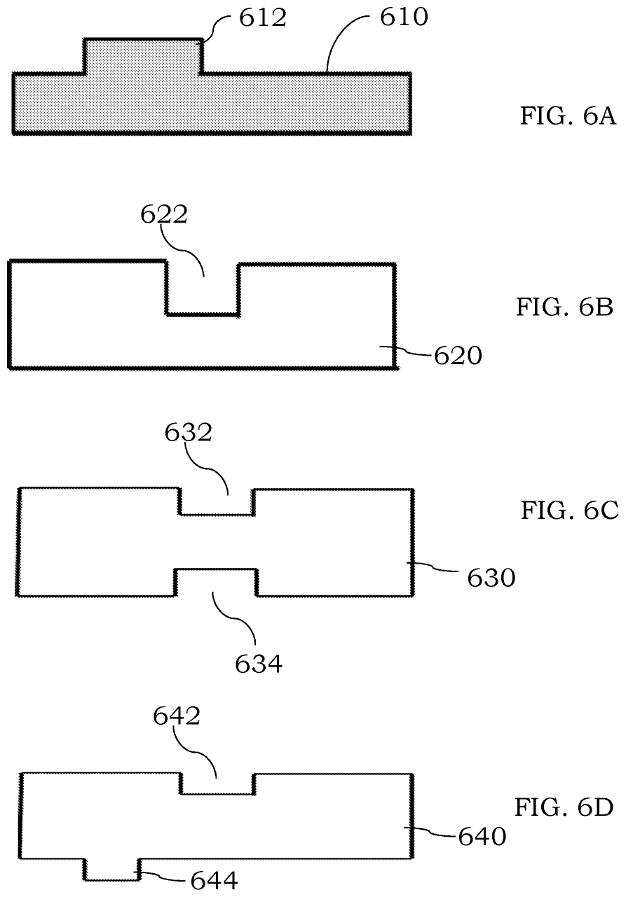

In certain embodiments, the sampler cone and the interface could each have a projection or other outward surface feature designed to mate to/engage a metal gasket. An illustration is shown in FIG. 5, where the sampler cone 510 includes a surface feature comprising a projection 512 on a surface that couples to a projection 532 on a surface of an interface 530 through a metal gasket 520. Tightening of the sampler cone 510 to the interface 530 through the threads of these components results in compression of the metal gasket 520 between the surface features 512, 532 and promotes a substantially fluid tight seal or a fluid tight seal between the components 510, 530. As noted above, configurations other than threads on the sampler cone and interface could also be used. The metal gasket 520 can be configured similar to the gaskets 220, 320 or 420. For example, the metal gasket 520 may be a single layer gasket or a multi-layer gasket. The metal gasket 520 may comprise a soft metal material that can compress at least to some degree as the sampler cone 510 is tightened to the interface 530. In some examples, the metal gasket 520 may comprise aluminum, nickel, brass, pure platinum, gold, copper or other transition metals that can compress or be crushed, to at least some degree, upon application of a force used to tighten the threads of the sampler cone 510 to the threads of the interface 530. As noted herein, a tool with a pre-set torque limit can be used to ensure the sampler cone 510 is tightened to the interface 530 to a suitable degree but not overtightened to deform the metal gasket 520 and disrupt any seal. The metal gasket 520 may also permit heat transfer from the sampler cone 510 to the interface 530 (or vice versa) as desired. The thickness of the gasket 520 can vary, for example, from about 0.1 mm to about 0.5 mm, though these values are merely illustrative and smaller or larger thicknesses could be used if desired. The gasket thickness is typically sized based on the height of the projections present on the surfaces of the sampler cone 510 and/or interface 530. For example, the projections on the interface 530 and the sampler cone 510 might each independently be around 0.2-1 mm high. The metal gasket 520 can be sized so it spans a width of each of the projections 512, 532 when the mating surfaces of the sampler cone 510 and interface 530 are coupled. The projections 512, 532 need not be planar and could instead adopt be many different geometries and shapes as desired including, for example, pointed projections, tapered projections, trapezoidal projections or projections of other shapes that are not necessarily planar.

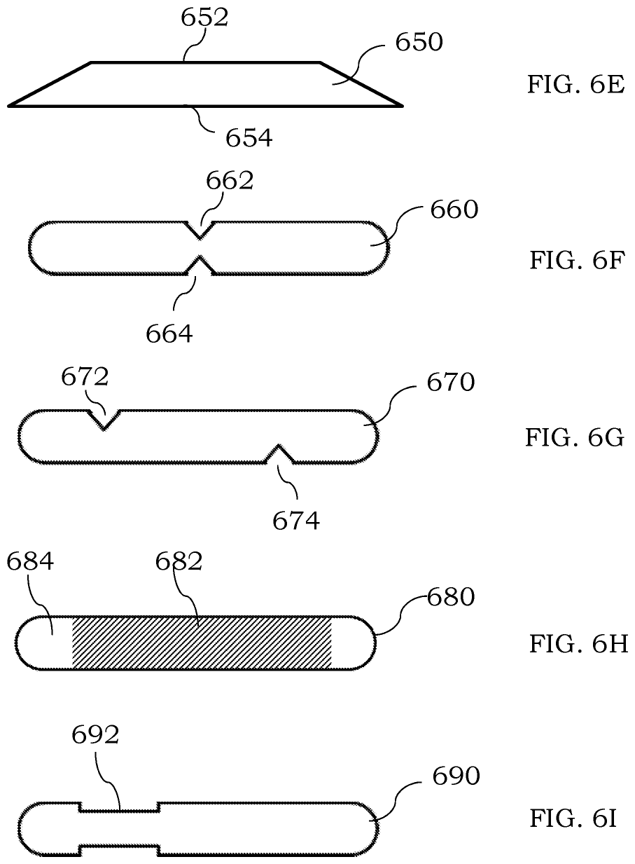

In certain embodiments, the metal gaskets described herein need not be planar. For example, the metal gasket may have its own shapes or surface features configured to couple to the surface features of a sampler cone and/or interface. One illustration is shown in FIG. 6A where a gasket 610 comprises a projection 612 on a top surface. Another configuration is shown in FIG. 6B where a gasket 620 comprises a U-shaped feature 622 that is configured to engage a projection from a sampler cone or an interface. An additional configuration is shown in FIG. 6C where a gasket 630 comprises U-shaped features 623, 624 on each of a top and bottom surface. Each of the U-shaped features 632, 634 can engage a projection from a sampler cone or an interface. The U-shaped features 632, 634 need not be positioned under each other as shown in FIG. 6C. Another configuration is shown in FIG. 6D where a gasket 640 comprises a U-shaped feature 642 on a top surface and a projection 644 on a bottom surface. An additional configuration is shown in FIG. 6E, where a top surface 652 of a gasket 650 comprises a smaller length than a bottom surface 654 of the gasket 650. Another configuration is shown in FIG. 6F, where a gasket 660 comprises non-planar recesses 662, 664 that can be used to receive projections on the sampler cone, interface or other component. Where recesses, projections or other features on the gasket are present, the features need not be positioned in the same vertical axis. Referring to FIG. 6G, a gasket 670 is shown that includes offset recesses 672, 674. By offsetting any recesses, increased gasket thickness can be present at areas designed to receive a projection (or other shaped feature) on the sampler cone, interface or other component. Other gasket shapes, surface features and configurations may also be used as desired. The various metal gasket surface features can be produced, for example, by machining the features into a solid metal body and then shaping, trimming, cutting, etc. the metal gasket into a desired shape to couple to the sampler cone and/or the interface.

In certain embodiments, the entire surface of the gasket need not be produced from the same material. For example, it may be desirable to match the materials used in the mating area surfaces of the gasket with those materials used in the cone, interface or other component such there is little or no difference in thermal expansion rates of the materials, e.g., little or no mismatch in the coefficients of thermal expansion, to maintain the substantially fluid tight seal over a wide temperature range. An illustration is shown in FIG. 6H, where the gasket 680 comprises a first material 682 at a surface of the gasket 680 that is designed to contact to the cone, interface or other component, and a second material 684, which is different than the first material 682, and is present at other areas of the gasket 680. Alternatively, the materials at mating surfaces of the gasket can be selected so they expand as they are heated from room temperature to operating temperature to fill in any void spaces that might exist between the gasket surface and the surfaces of the cone, interface or other component. In instances where the components to be coupled comprise different materials, e.g., where a surface feature on a sampler cone comprises a first material and a surface feature on an interface comprises a different material, a multi-layer gasket may be used with suitable materials present on each surface of the gasket to minimize any leaks that may result from thermal mismatch of different materials.

In other configurations, the gasket need not have the same thickness across its entire surface. Referring to FIG. 6I, a gasket 690 is shown that comprises a lower thickness at an area 692 than at other areas of the gasket 690. As noted herein, overall gasket thickness may vary and illustrative ranges include about 0.1 mm up to about 1 mm, e.g., about 0.1 mm to about 0.5 mm or about 0.2 mm to about 0.4 mm or about 0.2 mm to about 0.3 mm or about 0.2 mm, 0.21 mm, 0.22 mm, 0.23 mm, 0.24 mm or 0.25 mm. If desired, areas of the gasket 690 that are not intended to mate to a cone, interface or other component may have a larger thickness than area 692. Alternatively, the area 692 could instead have a larger thickness than other areas of the gasket 690.

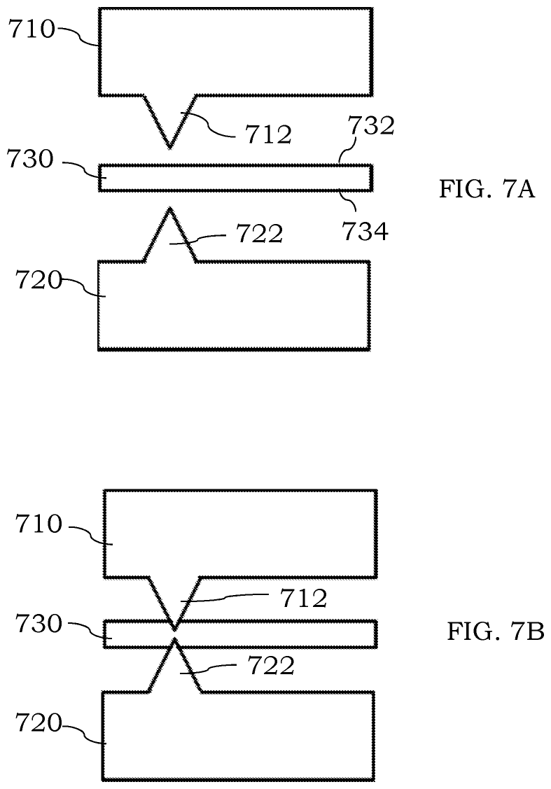

In certain examples, the gasket and surface features on the cone, interface or other component can be configured together to provide a desired sealing force between the components. Referring to FIG. 7A, an exploded or disassembled view of certain components including a first component 710, e.g. a sampler cone, comprising a surface projection 712, a second component 720, e.g., an interface, comprising a surface projection 722 and a gasket 730 are shown. The projections 712, 722 can be present on different components, e.g., one projection can be present on a sampler cone and the other projection can be present on an interface or other component. As the two components 710 and 720 are joined to each other, the component 710 can provide a force to a top surface 732 of the gasket 730 through the projection 712. The component 720 can provide a force to a bottom surface 734 of the gasket 730 through the projection 722. Depending on the overall shape of the projections 712, 722, it may be possible to amplify or focus the force applied to the gasket 730 at the specific areas of the gasket where the projections 712, 722 contact the gasket. For example, by applying the same force over a decreased surface area and applying a force to both surfaces of the gasket 730, it can be possible to provide a better seal between the components 710, 720. The exact thickness of the gasket 730 can vary from about 0.1 mm to about 1 mm, e.g., about 0.2 mm to about 0.5 mm. In some examples, the gasket thickness may be about 0.2 mm, about 0.25 mm or about 0.2 mm to about 0.25 mm thick. The gasket thickness need not be the same across the entire surface of the gasket 730. Further, the triangular shape shown for the projections 712, 722 is not required and other geometric shapes including, for example, square, rectangular, hexagonal, octagonal, etc. could be used if desired. In addition, the overall geometric shape of the projections 712, 722 need not be the same even though each of the projections 712, 722 may comprise a pointed or tipped surface that can engage a surface of the gasket 730. Similarly, a shape of the projections 712, 722 need not be triangular but could instead adopt other shapes where an end or vertex of the shape can engage a surface of the gasket 730. The exact dimensions of the projections 712, 722 can vary and need not be the same. For example, the projections 712, 722 may comprise a height of less than 1 mm.

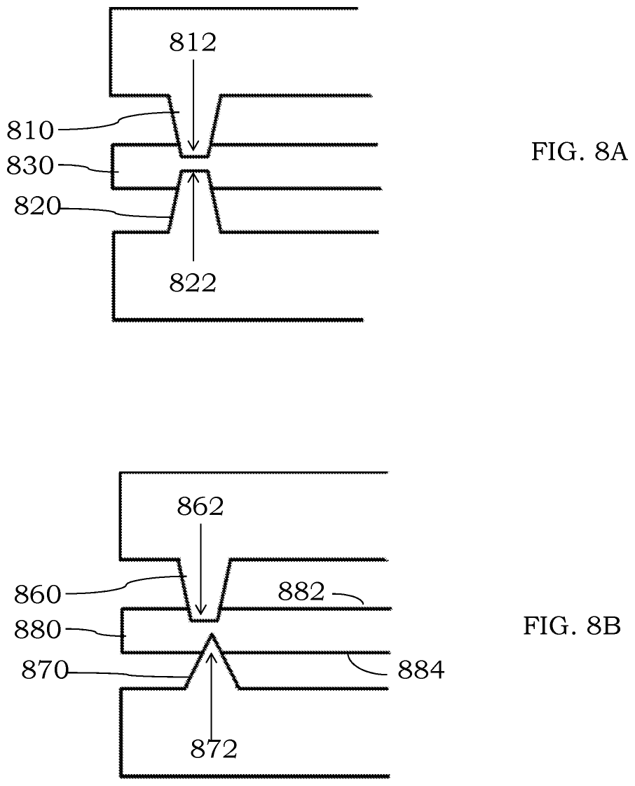

In other examples, the projections used to apply a force to the surfaces of the gasket need not be non-planar. For example, as shown in FIG. 8A, the projections 810, 820 may comprise a planar surface 812, 822, respectively, that can be used to provide a force to each surface of a gasket 830. The projections need not be aligned or be in the same vertical plane or even by the same. Referring to FIG. 8B, projection 860 comprises a planar surface 862 that can apply a force to a top surface 882 of the gasket. A projection 870 comprises a sharp point or tip 872 that can provide a force to a bottom surface 884 of the gasket 880. The tip 872 is also offset slightly from the middle of the planar surface 862 of the projection 860. The surface 862 and the tip 872 need not provide the same force to the gasket 880, but enough force is desirably provided through the surface 862 and the tip 872 to provide a substantially fluid tight seal between the various components. The exact thickness of the gasket 880 can vary from about 0.1 mm to about 1 mm, e.g., about 0.2 mm to about 0.5 mm. In some examples, the gasket thickness may be about 0.2 mm, about 0.25 mm or about 0.2 mm to about 0.25 mm thick. The gasket thickness need not be the same across the entire surface of the gasket 880. Further, the tetrahedral shape shown for the projections 812, 822 and 862 are not required and other geometric shapes including, for example, square, rectangular, hexagonal, octagonal, etc. could be used if desired. Similarly, a shape of the projection 872 need not be triangular but could instead adopt other shapes where an end or vertex of the shape can engage a surface of the gasket 880. The exact dimensions of the projections 812, 822, 862, 872 can vary and need not be the same. For example, the projections 812, 822, 862, 872 may comprise a height of less than 1 mm.

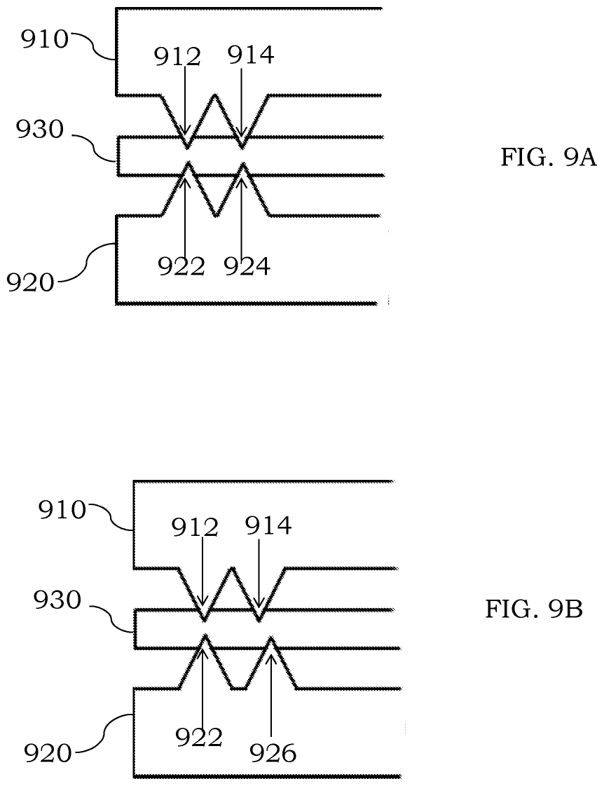

In other configurations, it may be desirable to use more than a single projection or recess on one or more of the components, e.g., on one or more of a sampler cone and an interface. While many different configurations are possible, one configuration is shown in FIG. 9A, where projections 912, 914 are present on a component 910, e.g., a sampler cone, and projections 922, 924 are present on another component 920, e.g., an interface. A gasket 930 can be present and used to provide a seal between the first component 910 and the second component 920. In this configuration, the projections 912 and 922 are aligned along the same vertical axis and provide a force to an area of the gasket 930 between them. Similarly, the projections 914 and 924 are aligned along the same vertical axis and provide a force to an area of the gasket 930 between them. If desired, however, one or more of the projections may be offset as shown in FIG. 9B, where a projection 926 is shown as being offset from the projection 914. The projections 912, 914, 922, 924 and 926 need not have the same shape or geometry. For example, one or more of the projections 912, 914, 922, 924 and 926 may comprise a different shape, e.g., a planar surface, than other projections. The exact thickness of the gasket 930 can vary from about 0.1 mm to about 1 mm, e.g., about 0.2 mm to about 0.5 mm. In some examples, the gasket thickness may be about 0.2 mm, about 0.25 mm or about 0.2 mm to about 0.25 mm thick. The gasket thickness need not be the same across the entire surface of the gasket 930. While two projections are shown on each of the components 910, 920, one of the components may have a single projection or more than two projections as surface features that can engage a gasket. If desired, each of the components 910, 920 may comprise more than two projections as surface features that can engage a gasket. The exact dimensions of the projections 912, 922, 922, 924 and 926 can vary and need not be the same. For example, the projections 912, 922, 922, 924 and 926 may comprise a height of less than 1 mm.

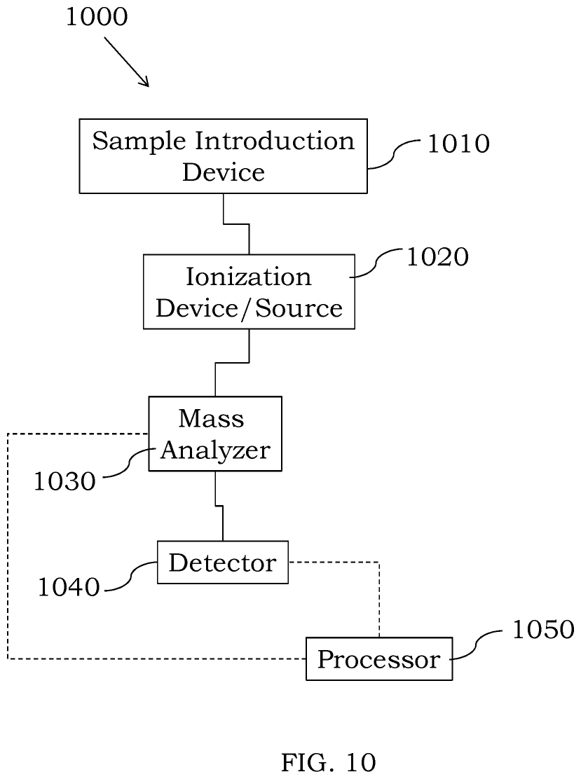

In certain embodiments, the sampler cone and metal gaskets, and other devices which can use a gasket to provide a substantially fluid tight seal described herein, can be used in a mass spectrometer system comprising many different components or stages. One illustration is shown in FIG. 10 where the mass spectrometer 1000 comprises a sample introduction device 1010, an ionization device/source 1020, a mass analyzer 1030 and a detector 1040. In some instances, the sample introduction device 1010 can be configured as an induction nebulizer, a non-induction nebulizer or a hybrid of the two, a concentric, cross flow, entrained, V-groove, parallel path, enhanced parallel path, flow blurring or piezoelectric nebulizers, a spray chamber, a chromatography device such as a gas chromatography device or other devices that can provide a sample to the ionization device/source 1020.

In some configurations, the ionization device/source 1020 may comprise many different types of devices that can receive a fluid from the sample introduction device 1010 and ionize/atomize analyte in the fluid sample. In some examples, the ionization device/source 1020 may comprise an inductively coupled plasma that can be produced using a torch and an induction device, a capacitively coupled plasma, an electron ionization device, a chemical ionization device, a field ionization source, desorption sources such as, for example, those sources configured for fast atom bombardment, field desorption, laser desorption, plasma desorption, thermal desorption, electrohydrodynamic ionization/desorption, etc., thermospray or electrospray ionization sources or other types of ionization sources. Notwithstanding that many different types of ionization devices/sources 1020 can be used, the ionization device/source 1020 typically ionizes analyte ions in the sample and provides them in a fluid beam downstream to a sampler cone and into the mass analyzer 730 where the ions/atoms can be separated/selected based on different mass-to-charge ratios. Various types of ionization devices/sources and associated componentry can be found, for example, in commonly assigned U.S. Pat. Nos. 10,096,457, 9,942,974, 9,848,486, 9,810,636, 9,686,849 and other patents currently owned by PerkinElmer Health Sciences, Inc. (Waltham, MA) or PerkinElmer Health Sciences Canada, Inc. (Woodbridge, Canada).

In some examples, the mass analyzer 1030 may take numerous forms depending generally on the sample nature, desired resolution, etc. and exemplary mass analyzers may comprise one or more rod assemblies such as, for example, a quadrupole or other rod assembly. The mass analyzer 1030 may comprise one or more cones, e.g., a skimmer cone, sampling cone, an interface, ion guides, collision cells, lenses and other components that can be used to sample an entering beam received from the ionization device/source 1020. The various components can be selected to remove interfering species, remove photons and otherwise assist in selecting desired ions from the entering fluid comprising the ions. In some examples, the mass analyzer 1030 may be, or may include, a time of flight device. In some instances, the mass analyzer 1030 may comprise its own radio frequency generator. In certain examples, the mass analyzer 1030 can be a scanning mass analyzer, a magnetic sector analyzer (e.g., for use in single and double-focusing MS devices), a quadrupole mass analyzer, an ion trap analyzer (e.g., cyclotrons, quadrupole ions traps), time-of-flight analyzers (e.g., matrix-assisted laser desorbed ionization time of flight analyzers), and other suitable mass analyzers that can separate species with different mass-to-charge ratios. If desired, the mass analyzer 1030 may comprise two or more different devices arranged in series, e.g., tandem MS/MS devices or triple quadrupole devices, to select and/or identify the ions that are received from the ionization device/source 1020. Various components that can be present in a mass analyzer are described, for example, in commonly owned U.S. Pat. Nos. 10,032,617, 9,916,969, 9,613,788, 9,589,780, 9,368,334, 9,190,253 and other patents currently owned by PerkinElmer Health Sciences, Inc. (Waltham, MA) or PerkinElmer Health Sciences Canada, Inc. (Woodbridge, Canada).

In some examples, the detector 1040 may be any suitable detection device that may be used with existing mass spectrometers, e.g., electron multipliers, Faraday cups, coated photographic plates, scintillation detectors, multi-channel plates, etc., and other suitable devices that will be selected by the person of ordinary skill in the art, given the benefit of this disclosure. Illustrative detectors that can be used in a mass spectrometer are described, for example, in commonly owned U.S. Pat. Nos. 9,899,202, 9,384,954, 9,355,832, 9,269,552, and other patents currently owned by PerkinElmer Health Sciences, Inc. (Waltham, MA) or PerkinElmer Health Sciences Canada, Inc. (Woodbridge, Canada).

In certain instances, the mass spectrometer system may also comprise a processor 1050, which typically take the forms of a microprocessor and/or computer and suitable software for analysis of samples introduced into the mass spectrometer 1000. While the processor 1050 is shown as being electrically coupled to the mass analyzer 1030 and the detector 1040, it can also be electrically coupled to the other components shown in FIG. 10 to generally control or operate the different components of the system 1000. In some embodiments, the processor 1050 can be present, e.g., in a controller or as a stand-alone processor, to control and coordinate operation of the system 1000 for the various modes of operation using the system 1000. For this purpose, the processor can be electrically coupled to each of the components of the system 1000, e.g., one or more pumps, one or more voltage sources, rods, etc., as well as any other voltage sources included in the system 700.

In certain configurations, the processor 1050 may be present in one or more computer systems and/or common hardware circuity including, for example, a microprocessor and/or suitable software for operating the system, e.g., to control the voltages of the ion source, pumps, mass analyzer, detector, etc. In some examples, any one or more components of the system 700 may comprise its own respective processor, operating system and other features to permit operation of that component. The processor can be integral to the systems or may be present on one or more accessory boards, printed circuit boards or computers electrically coupled to the components of the system. The processor is typically electrically coupled to one or more memory units to receive data from the other components of the system and permit adjustment of the various system parameters as needed or desired. The processor may be part of a general-purpose computer such as those based on Unix, Intel PENTIUM-type processor, Apple A series processors, Motorola PowerPC, Sun UltraSPARC, Hewlett-Packard PA-RISC processors, or any other type of processor. One or more of any type computer system may be used according to various embodiments of the technology. Further, the system may be connected to a single computer or may be distributed among a plurality of computers attached by a communications network. It should be appreciated that other functions, including network communication, can be performed and the technology is not limited to having any particular function or set of functions. Various aspects may be implemented as specialized software executing in a general-purpose computer system. The computer system may include a processor connected to one or more memory devices, such as a disk drive, memory, or other device for storing data. Memory is typically used for storing programs, calibrations and data during operation of the system in the various modes using the gas mixture. Components of the computer system may be coupled by an interconnection device, which may include one or more buses (e.g., between components that are integrated within a same machine) and/or a network (e.g., between components that reside on separate discrete machines). The interconnection device provides for communications (e.g., signals, data, instructions) to be exchanged between components of the system. The computer system typically can receive and/or issue commands within a processing time, e.g., a few milliseconds, a few microseconds or less, to permit rapid control of the system 1000. For example, computer control can be implemented to control the vacuum pressure, to control voltages provided to the mass analyzer, etc. The processor typically is electrically coupled to a power source which can, for example, be a direct current source, an alternating current source, a battery, a fuel cell or other power sources or combinations of power sources. The power source can be shared by the other components of the system. The system may also include one or more input devices, for example, a keyboard, mouse, trackball, microphone, touch screen, manual switch (e.g., override switch) and one or more output devices, for example, a printing device, display screen, speaker. In addition, the system may contain one or more communication interfaces that connect the computer system to a communication network (in addition or as an alternative to the interconnection device). The system may also include suitable circuitry to convert signals received from the various electrical devices present in the systems. Such circuitry can be present on a printed circuit board or may be present on a separate board or device that is electrically coupled to the printed circuit board through a suitable interface, e.g., a serial ATA interface, ISA interface, PCI interface or the like or through one or more wireless interfaces, e.g., Bluetooth, Wi-Fi, Near Field Communication or other wireless protocols and/or interfaces.

In certain embodiments, the storage system used in the systems described herein typically includes a computer readable and writeable non-volatile recording medium in which codes can be stored that can be used by a program to be executed by the processor or information stored on or in the medium to be processed by the program. The medium may, for example, be a hard disk, solid state drive or flash memory. Typically, in operation, the processor causes data to be read from the non-volatile recording medium into another memory that allows for faster access to the information by the processor than does the medium. This memory is typically a volatile, random access memory such as a dynamic random access memory (DRAM) or static memory (SRAM). It may be located in the storage system or in the memory system. The processor generally manipulates the data within the integrated circuit memory and then copies the data to the medium after processing is completed. A variety of mechanisms are known for managing data movement between the medium and the integrated circuit memory element and the technology is not limited thereto. The technology is also not limited to a particular memory system or storage system. In certain embodiments, the system may also include specially-programmed, special-purpose hardware, for example, an application-specific integrated circuit (ASIC) or a field programmable gate array (FPGA). Aspects of the technology may be implemented in software, hardware or firmware, or any combination thereof. Further, such methods, acts, systems, system elements and components thereof may be implemented as part of the systems described above or as an independent component. Although specific systems are described by way of example as one type of system upon which various aspects of the technology may be practiced, it should be appreciated that aspects are not limited to being implemented on the described system. Various aspects may be practiced on one or more systems having a different architecture or components. The system may comprise a general-purpose computer system that is programmable using a high-level computer programming language. The systems may be also implemented using specially programmed, special purpose hardware. In the systems, the processor is typically a commercially available processor such as the well-known Pentium class processors available from the Intel Corporation. Many other processors are also commercially available. Such a processor usually executes an operating system which may be, for example, the Windows 95, Windows 98, Windows NT, Windows 2000 (Windows ME), Windows XP, Windows Vista, Windows 7, Windows 8 or Windows 10 operating systems available from the Microsoft Corporation, MAC OS X, e.g., Snow Leopard, Lion, Mountain Lion or other versions available from Apple, the Solaris operating system available from Sun Microsystems, or UNIX or Linux operating systems available from various sources. Many other operating systems may be used, and in certain embodiments a simple set of commands or instructions may function as the operating system.

In certain examples, the processor and operating system may together define a platform for which application programs in high-level programming languages may be written. It should be understood that the technology is not limited to a particular system platform, processor, operating system, or network. Also, it should be apparent to those skilled in the art, given the benefit of this disclosure, that the present technology is not limited to a specific programming language or computer system. Further, it should be appreciated that other appropriate programming languages and other appropriate systems could also be used. In certain examples, the hardware or software can be configured to implement cognitive architecture, neural networks or other suitable implementations. If desired, one or more portions of the computer system may be distributed across one or more computer systems coupled to a communications network. These computer systems also may be general-purpose computer systems. For example, various aspects may be distributed among one or more computer systems configured to provide a service (e.g., servers) to one or more client computers, or to perform an overall task as part of a distributed system. For example, various aspects may be performed on a client-server or multi-tier system that includes components distributed among one or more server systems that perform various functions according to various embodiments. These components may be executable, intermediate (e.g., IL) or interpreted (e.g., Java) code which communicate over a communication network (e.g., the Internet) using a communication protocol (e.g., TCP/IP). It should also be appreciated that the technology is not limited to executing on any particular system or group of systems. Also, it should be appreciated that the technology is not limited to any particular distributed architecture, network, or communication protocol.

In some instances, various embodiments may be programmed using an object-oriented programming language, such as, for example, SQL, SmallTalk, Basic, Java, Javascript, PHP, C++, Ada, Python, iOS/Swift, Ruby on Rails or C# (C-Sharp). Other object-oriented programming languages may also be used. Alternatively, functional, scripting, and/or logical programming languages may be used. Various configurations may be implemented in a non-programmed environment (e.g., documents created in HTML, XML or other format that, when viewed in a window of a browser program, render aspects of a graphical-user interface (GUI) or perform other functions). Certain configurations may be implemented as programmed or non-programmed elements, or any combination thereof. In some instances, the systems may comprise a remote interface such as those present on a mobile device, tablet, laptop computer or other portable devices which can communicate through a wired or wireless interface and permit operation of the systems remotely as desired.

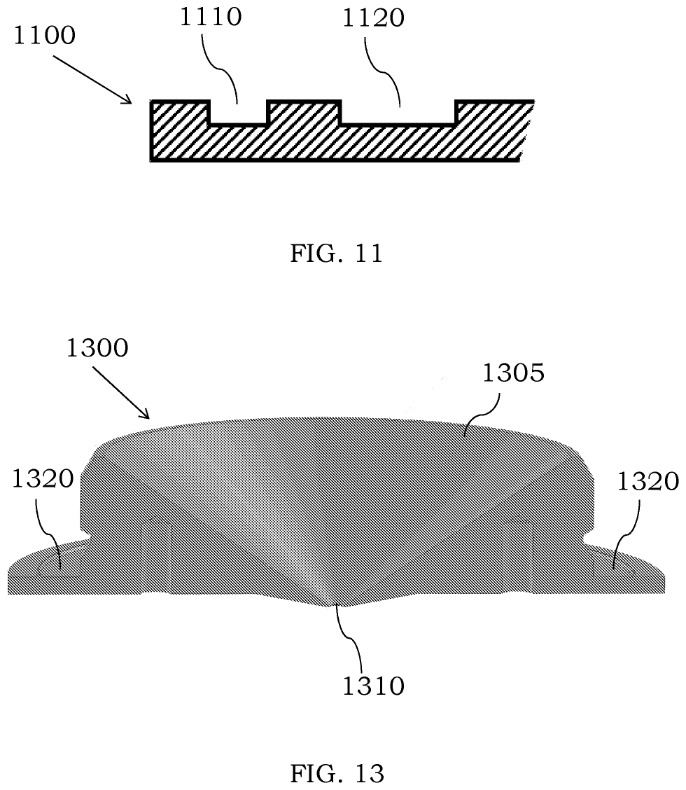

In some embodiments, one or both of the sampler cone or interface may comprise more than one surface feature. Referring to FIG. 11, a cross-section of a portion of a sampler cone is shown that comprises a first recess 1110 and a second recess 110 spaced from the first recess 1110. Each of the recesses 1110, 1120 can be sized differently and may be configured to engage a respective metal gasket (not shown) and/or a surface feature from an interface to compress the metal gasket between all of the surface features. If desired, a single metal gasket can span across both recesses 1110, 1120 and be crushed when the recesses 1110, 820 engage a respective projection of another component. An interface may comprise two or more suitable surface features that can also engage/receive or otherwise couple to each of the metal gaskets. Threads of the sampler cone can couple to threads of the interface to compress each of the gaskets in the recesses 1110, 1120. As noted above, configurations other than threads on the sampler cone and interface could also be used. By using two metal gaskets in combination with two surface features on the sampler cone and the interface, enhanced sealing between the sampler cone and the interface can be achieved. If desired, three, four or more separate surface features can be present on each of the sampler cone and the interface, and each can be configured to engage a respective metal gasket.

In certain embodiments, the sampler cone, metal gasket and/or interface can be present in a kit that can be used to retrofit an existing MS system with the various components. A tool with a pre-set torque may also be included in the kit to tighten the sampler cone to the interface using an appropriate amount of torque. The kit, for example, may comprise a sampler cone comprising a sample orifice configured to fluidically couple to an ionization source that provides an ionized sample comprising ions to the sample orifice, wherein the sampler cone comprises a first surface feature configured to engage a second surface feature on an interface. The kit may also comprise a metal gasket sized and arranged to be placed between the first surface feature of the sampler cone and the second surface feature of the interface and configured to be crushed between the first surface feature of the sampler cone and the second surface feature of the interface when the sampler cone is coupled to the interface of the mass analyzer. The kit may further comprise instructions for using the sampler cone and the metal gasket to couple the sampler cone to the interface of the mass analyzer to provide a substantially fluid tight seal between the sampler cone and the interface of the mass analyzer. If desired, the kit may also comprise an interface. If desired, the kit may also comprise a tool, e.g., a wrench, driver, ratchet, etc., comprising a pre-set torque to tighten the sampler cone to the interface to crush the metal gasket and provide the substantially fluid tight seal without overtightening the sampler cone. In other embodiments, the kit may comprise more than one type of gasket, gaskets of different thicknesses or gaskets comprising different materials.

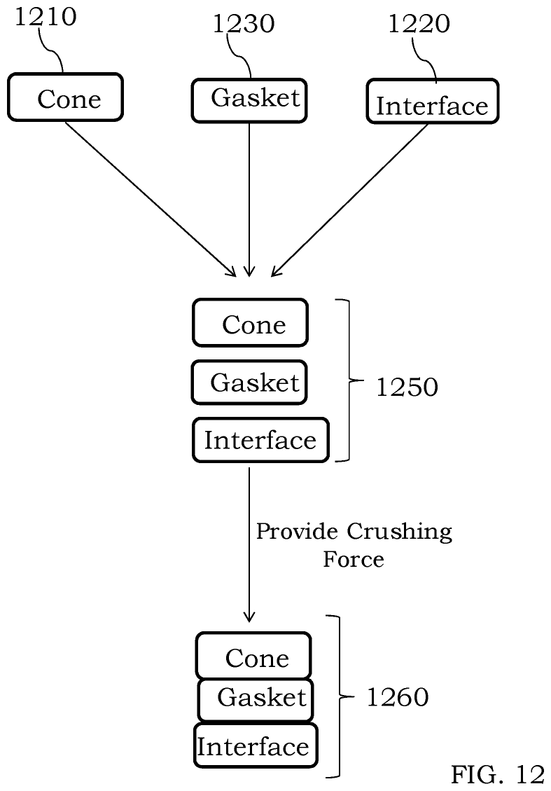

In certain embodiments, a method can be implemented to couple a sampler cone to a mass analyzer interface to provide a substantially fluid tight seal between the sampler cone and the mass analyzer interface. The method is shown in FIG. 12. The method comprises assembling or placing a gasket 1230 between the sampler cone 1210 and the interface 1220 to provide an assembly 1250 with the gasket 1230 being positioned between a first surface feature of the sampler cone 120 and a second surface feature of the interface 1220. Once assembled, a force can be provided to crush the metal gasket 1230 between the first surface feature of the sampler cone 1210 and the second surface feature of the mass analyzer interface 1230 to provide the substantially fluid tight seal between the sampler cone 1210 and the mass analyzer interface 1220 and to assembly the sampler cone 1210 to the interface 1220 and form an assembly 1260. In some embodiments, the method may also comprise tightening first threads of the sampler cone to second threads of the mass analyzer interface to a selected torque value to crush the metal gasket between the first surface feature and the second surface feature. In other examples, the method may comprise compressing a gasket of about 0.2 to about 0.25 mm using pointed surface features on one or both of the sampler cone 1210 and the interface 1220. For example, the sampler cone 1210 and the interface 1220 can be coupled to each other using internal threads, external fasteners or other means.

Certain specific examples are described to facilitate a better understanding of some of the novel and inventive aspects of the technology described herein.

### Example 1

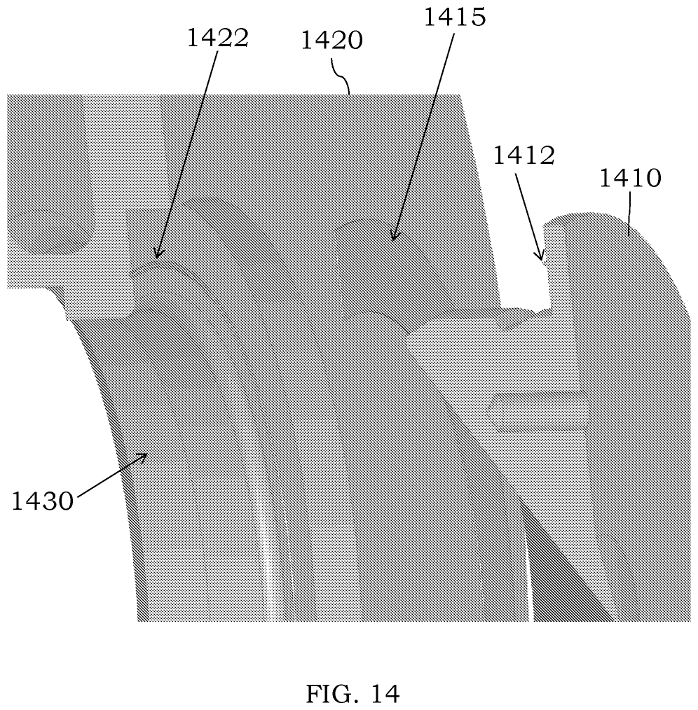

Referring to FIG. 13, a cross-section of a sampler cone 1300 is shown. The sampler cone 1300 comprises a body 1305 and a sample orifice 1310 that can permit entry of sample into the sampler cone 1300. The base of the sampler cone 1300 comprises a generally annular recess or cut 1320 that can engage a projection on an interface (not shown) through a metal gasket. Once the sampler cone 1300 is threaded onto the interface, as the groove of the interface is forced into the annular recess, the metal gasket gets crushed between the groove/recess surfaces provides a seal between the sampler cone 1300 and the interface. The crush seal is not as dependent on the surface finish of the sampler cone and interface as are conventional devices and methods used to couple a sampler cone to an interface.

### Example 2

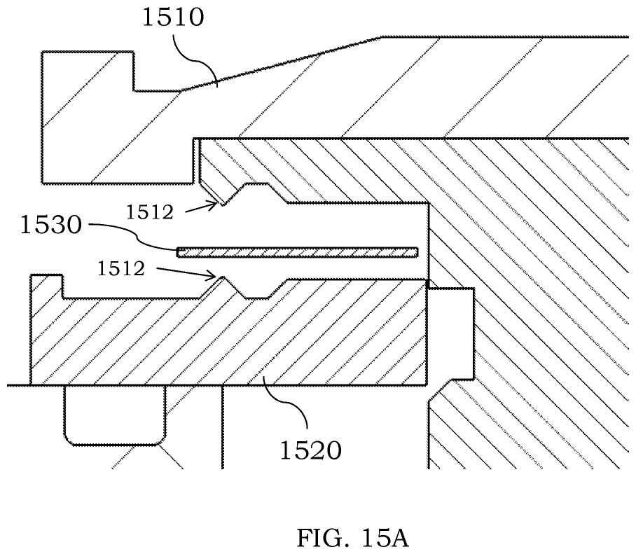

Referring to FIG. 14, an illustration of a sampler cone and an interface is shown. The sampler cone 1410 comprises a projection 1412 that extends away from a bottom surface of the sampler cone. An interface 1420 comprises a groove 1422 that can engage the projection 1412 of the sampler cone 1410. A metal gasket 1415 can be positioned between the groove 1422 and the projection 1412. As the sampler cone 1410 is tightened to the interface using internal threads 1420 on the interface and threads on the sampler cone 1420 (not shown), the projection 1412 is forced into the groove 1422 and crushes the gasket 1415. This crushing of the gasket 1015 provides a substantially fluid tight seal between the sampler cone 1410 and the interface 1420.

### Example 3

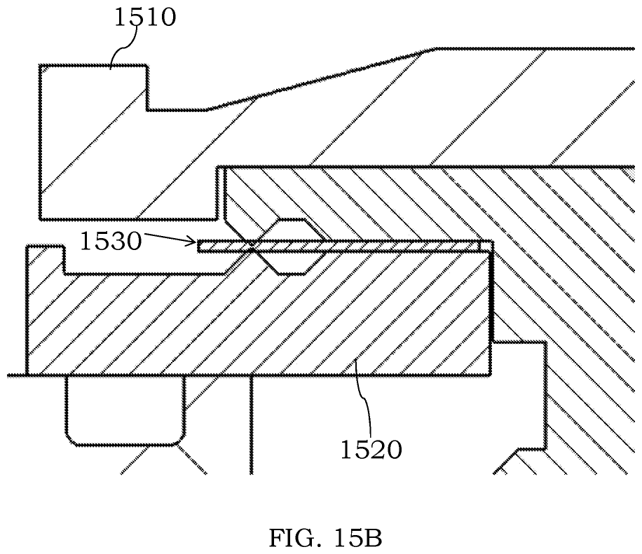

Referring to FIG. 15A, a disassembled view of a sampler cone 1510, an interface 1520 and a gasket 1530 are shown. The sampler cone 1510 comprises a surface feature 1512 configured as a triangular shaped projection. The interface 1520 also comprises a surface feature 1522 configured as a triangular shaped projection 1522. When the cone 1510 is coupled to the interface 1520 (see FIG. 15B), the tips of the projections 1512, 1522 provide a compressive force to surfaces of the gasket 1530 to crush the gasket 1530 at these areas. By selecting the projections 1512, 1522 to have a point or tip, a selected amount of force can be provided to a small area of the gasket, which can enhance the resulting fluid seal that is formed.

When introducing elements of the examples disclosed herein, the articles “a,” “an,” “the” and “said” are intended to mean that there are one or more of the elements. The terms “comprising,” “including” and “having” are intended to be open-ended and mean that there may be additional elements other than the listed elements. It will be recognized by the person of ordinary skill in the art, given the benefit of this disclosure, that various components of the examples can be interchanged or substituted with various components in other examples.

Although certain aspects, examples and embodiments have been described above, it will be recognized by the person of ordinary skill in the art, given the benefit of this disclosure, that additions, substitutions, modifications, and alterations of the disclosed illustrative aspects, examples and embodiments are possible.

1. (canceled)

2. A system comprising:
a mass analyzer cone comprising a first surface, wherein the first surface comprises a projection;
a mass analyzer comprising a second surface, wherein the second surface comprises a recess configured to receive the projection; and
a metal gasket disposed between the first surface and the second surface,
wherein the first surface and the second surface are configured to provide a substantially fluid-tight seal by crushing the metal gasket into the recess based on the mass analyzer cone being coupled to the mass analyzer.

3. The system of claim 2, wherein the projection and the recess each comprise a substantially triangular-shaped cross-section.

4. The system of claim 2, wherein the projection and the recess each comprise:
a substantially square-shaped cross-section; or
a substantially rectangular-shaped cross-section.

5. The system of claim 2, wherein the mass analyzer cone comprises a sampler cone.

6. The system of claim 2, wherein:
the mass analyzer cone further comprises first threads;
the mass analyzer further comprises second threads; and
the mass analyzer cone is configured to be coupled to the mass analyzer by engaging the first threads with the second threads.

7. The system of claim 2, wherein each of the mass analyzer cone and the metal gasket comprises a material having substantially similar coefficient of thermal expansion.

8. The system of claim 2, wherein the metal gasket comprises a thickness of about 0.1 mm to about 0.5 mm.

9. An apparatus comprising:
a mass analyzer cone comprising:
a first surface comprising a projection configured to be received by a recess of a second surface of a mass analyzer,
wherein the first surface is configured to provide a substantially fluid-tight seal by crushing a metal gasket into the recess based on the mass analyzer cone being coupled to the mass analyzer.

10. The apparatus of claim 9, wherein the projection comprises a substantially triangular-shaped cross-section.

11. The apparatus of claim 9, wherein the projection comprises:
a substantially square-shaped cross-section; or
a substantially rectangular-shaped cross-section.

12. The apparatus of claim 9, wherein the mass analyzer cone comprises a sampler cone.

13. The apparatus of claim 9, wherein:
the mass analyzer cone further comprises first threads; and
the mass analyzer cone is configured to be coupled to the mass analyzer by engaging the first threads with second threads, of the mass analyzer.

14. A kit, comprising:
a metal gasket; and
a mass analyzer cone comprising a first surface comprising a projection configured to be received by a recess of a second surface of a mass analyzer,
wherein the first surface is configured to provide a substantially fluid-tight seal by crushing the metal gasket into the recess based on the mass analyzer cone being coupled to the mass analyzer.

15. The kit of claim 14, wherein the projection comprises a substantially triangular-shaped cross-section.

16. The kit of claim 14, wherein the projection comprises:
a substantially square-shaped cross-section; or
a substantially rectangular-shaped cross-section.

17. The kit of claim 14, wherein the metal gasket comprises an aluminum gasket.

18. The kit of claim 14, wherein the mass analyzer cone comprises a sampler cone.

19. The kit of claim 14, wherein:
the mass analyzer cone further comprises first threads; and
the mass analyzer cone is configured to be coupled to the mass analyzer by engaging the first threads with second threads, of the mass analyzer.

20. The kit of claim 14, wherein each of the mass analyzer cone and the metal gasket comprises material having a substantially similar coefficient of thermal expansion.

21. The kit of claim 14, wherein the metal gasket comprises a thickness of about 0.1 mm to about 0.5 mm.
